(19) United States
(12) Patent Application Publication
(10) Pub. No.: US 2018/0219429 A1
(43) Pub. Date: Aug. 2, 2018

(54) APPARATUS AND METHOD FOR DETECTION OF A FOREIGN BODY IN AN ELECTROMAGNETIC FIELD

(71) Applicant: Conti Temic microelectronic GmbH, Nuemberg (DE)

(72) Inventors: Thomas BAREISS, Bad Waldsee (DE); Christian WOHLWENDER, Ostrach (DE)

(21) Appl. No.: 15/747,357

(22) PCT Filed: Jul. 14, 2016
(86) PCT No.: PCT/EP2016/066729

§ 371 Date: Jan. 24, 2018

(30) Foreign Application Priority Data
Jul. 24, 2015 (DE) 10 2015 213 981.6

(51) Int. Cl. H02J 50/60; H02J 7/02; H02J 50/10; H04B 5/00

(52) U.S. Cl. CPC H02J 50/60; H04B 5/0037; H02J 50/10; H02J 7/025

(57) ABSTRACT

The invention relates to methods and an apparatus for the detection of a foreign body (Fre) by a charging apparatus (Pri, Bau) of a motor vehicle (Kfz), characterized in that it is configured to compare a gain control value (AGC) of a component (Bau) with a stored reference value (Ref), particularly for the device to be charged (Tel) (ECU; Bau), and, in the event of a discrepancy, to establish that a foreign body (Fre) has been detected (ECU; Bau).

The invention relates to methods and apparatuses for detecting foreign bodies.

US 2013/0093387 A1 describes inductive charging e.g. of a telephone in an automobile according to a WPC standard and with tuning using NFC near field communication. DE 10 2004 023 197 B describes wireless charging of a motor vehicle key in a charging cradle of a wireless power transmission device.

It is an object of the invention to optimize methods and apparatuses for detecting a foreign body for a charging apparatus of a motor vehicle. The object is achieved in each case by the subject matter of the independent patent claims. Some particularly advantageous refinements of the invention are specified in the subclaims and the description. Refinements of the invention can allow efficient detection of a foreign body.

Further features and advantages of some advantageous refinements of the invention will emerge from the description that follows of exemplary embodiments of the invention with reference to the drawing, in which, to illustrate some possible refinements of the invention,

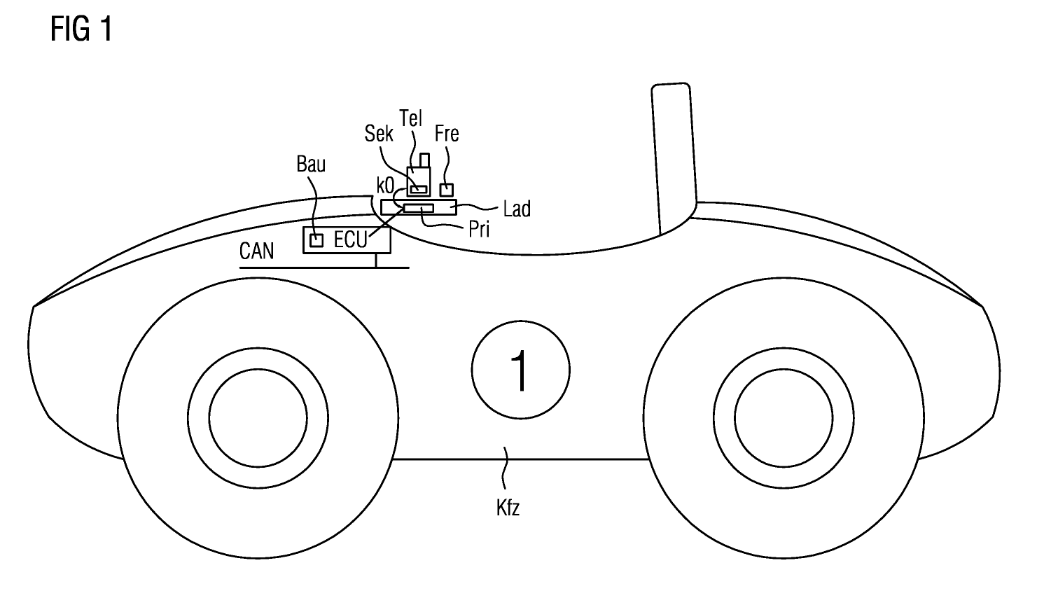

FIG. 1 shows a simplified schematic depiction of detection of a foreign body by a charging apparatus in a motor vehicle,

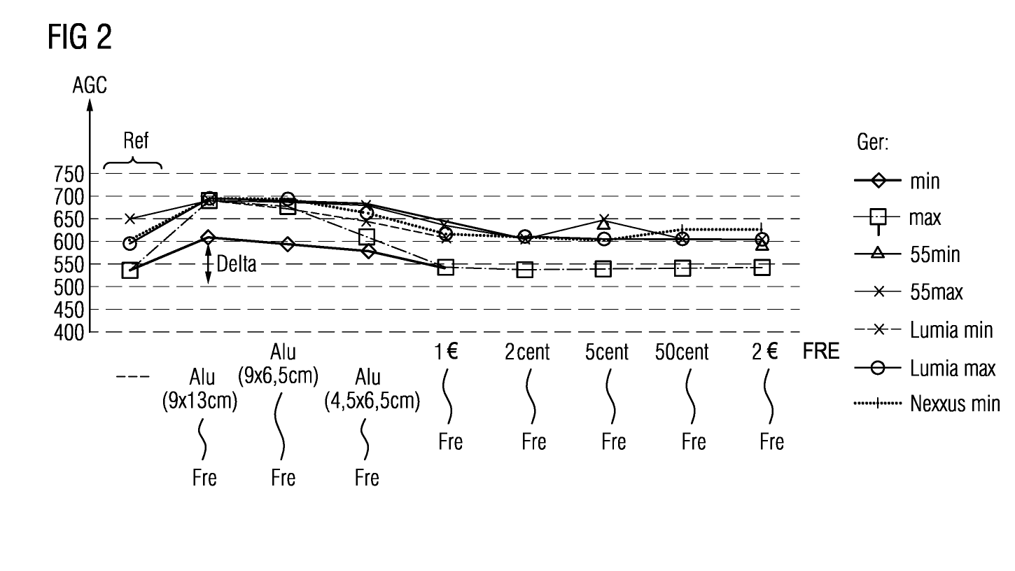

FIG. 2 shows a simplified schematic depiction of influences of different foreign bodies such as aluminum foils or coins on AGC values, during the charging and/or (NFC) communication of the charging apparatus with different mobile phones,

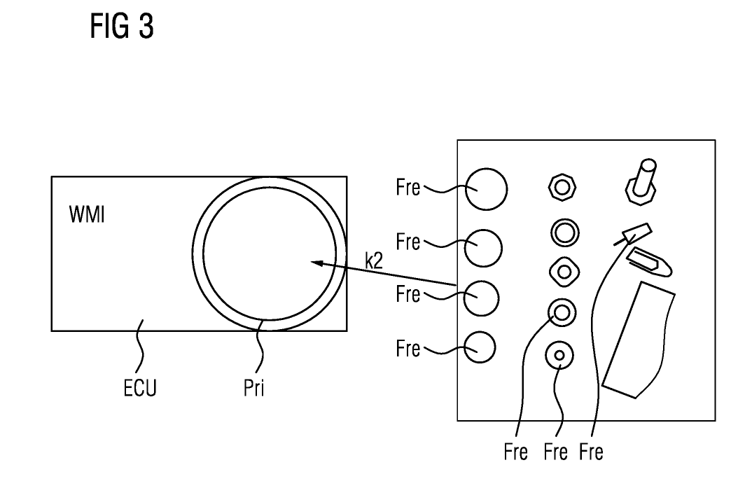

FIG. 3 shows a simplified schematic depiction of a charging apparatus and different foreign bodies influencing it.

FIG. 1 explains gain-control-value-based (AGC) detection of a foreign body Fre according to a refinement of the invention by showing a charging apparatus, arranged and/or mounted in a motor vehicle Kfz, with a charging cradle Lad and with a primary coil Pri for wirelessly charging (e.g. according to WPC, Qi, etc.) a device to be charged Tel (such as e.g. a mobile phone or smartphone or car key) via the coupled (k0) (to the primary coil Pri) secondary coil Sek thereof.

For communication between the charging device on the motor vehicle Kfz and the device to be charged Tel, there may be provision e.g. for communication by modulation via the charging coils Pri, Sek and/or near field communication such as e.g. NFC via the charging coils Pri, Sek and/or further coils/antennas, as a result of which e.g. the device to be charged Tel can be identified by the charging device and e.g. parameters for the charging of an energy store (e.g. a battery) in the device to be charged Tel can be activated on the basis thereof.

The (primary coil Pri and possibly controller ECU,Bau of the) charging apparatus may be powered e.g. by a car battery of the motor vehicle Kfz. The charging apparatus can be controlled e.g. by a controller (e.g. in an ECU and/or in the charging cradle) of the motor vehicle Kfz and/or via a (CAN etc.) bus CAN of the motor vehicle Kfz.

A controller ECU can store reference values Ref relating to previously known and/or already measured—in the motor vehicle Kfz—gain control values AGC (such as e.g. AGC or automatic gain control values) of a component Bau actuating the primary coil Pri and/or an (NFC/WLAN) communication coil during the charging of at least the device Tel (and possibly a few or many other devices that are possibly to be charged).

These reference values may be particularly gain control values or automatic gain control (AGC) values that are used by a component Bau (particularly an NFC near field communication chip for controlling near field communication (NFC) and/or an NFC3340 chip) e.g. for the automatic control/regulation of the power transferred from a driver to the primary antenna Pri and/or a further (NFC etc.) antenna and/or for antenna diagnosis. AGC values can be continually determined e.g. by a component Bau (such as e.g. an NFC3340 chip) and used for readjustment of the power to be emitted that is transferred from a driver to an antenna (Pri etc.).

According to refinements of the invention, automatic gain control (AGC) values are used for detecting a foreign body Fre by virtue of their being compared with stored reference values Ref for one or more chargeable devices Tel.

A device to be charged Tel can be identified e.g. via the charging coils Pri, Sek and/or by means of near field communication NFC (if need be also via a further antenna) and/or by means of WLAN and/or RFID and/or a mobile radio link, and an automatic gain control (AGC) value already known and/or stored for the identified device Tel can be compared with the currently measured automatic gain control (AGC) value in order to establish whether, apart from the (possibly identified) device to be charged Tel, a foreign body Fre such as e.g. (but not only) a piece of aluminum foil or a coin is in proximity (which causes a change of AGC) to the charging station, because the foreign body Fre can influence the field emitted by the primary coil Pri and can therefore trigger automatic readjustment of the transmission power by alteration of the present automatic gain control (AGC) value; the (AGC) can thus also be used for detection of a foreign body Fre in the area of the charging apparatus, e.g. when a prescribed threshold value for the difference between the present automatic gain control (AGC) value and the automatic gain control (AGC) value expected for the device to be charged Tel is exceeded (and/or a certain time for which said prescribed threshold value is exceeded is exceeded).

The left-hand side of FIG. 2 shows an example (without foreign bodies) of automatic gain control (AGC) values AGC that are known for some devices (mobile phones such as e.g. S5, Lumia, Nexus) and/or already measured during charging thereof (without foreign bodies) (minimum=min and maximum=max) and that may be stored as reference values Ref (in an ECU etc.),

and that can be compared with automatic gain control (AGC) values AGC currently determined by an (NFC3340 chip etc.) component Bau in order to detect the presence of a foreign body Fre in the area of the charging apparatus,
that is to say e.g. (from the second position on the left to the right) a foreign body in the form of a 9*13 cm aluminum foil, a 9*6.5 cm aluminum foil, a 4.5*6.5 cm aluminum foil, a 1 euro coin, a 2 cent coin, a 5 cent coin, a 50 cent coin and a 2 euro coin.

In the case of a foreign body Fre in the form of an aluminum foil, the AGC value in this case reaches saturation and could disturb communication with the mobile phone Tel.

If, before or during wireless charging of a device Tel via the charging coils Pri, Sek using an AC-generated field, the physical area of the charging station contains foreign bodies Fre in the form of metal bodies such as coins, rings, foils, paperclips etc., then eddy current losses in the metal bodies and/or additional heating of the charging surface (on Pri and/or Sek) by the foreign metal bodies and/or power drain (and hence the absence of part of the power for charging by the charging apparatus) can arise.

Thus, if, before or during wireless charging of a device Tel, a foreign body Fre, particularly in the form of metal bodies, is detected in the physical area of the charging station, the user of the charging apparatus can be asked to remove this foreign body and/or charging can be interrupted (e.g. after a certain period of time or generally).

Refinements of the invention may be realizable relatively easily and possibly without additional hardware complexity.

FIG. 3 shows, on the left, a simplified depiction of a (WMI) charging apparatus with an antenna Pri and a controller (ECU) and, on the right, foreign bodies Fre to be detected, such as coins, disks, paperclips, that are detectable with refinements of the invention because they couple (k2) to the antenna Pri of the charging apparatus and influence the AGC value.

1. An apparatus for detecting of a foreign body by a charging apparatus of a motor vehicle, comprising:
a component with a respective gain control value, and
a controller configured to compare the gain control value of the component with a stored reference value for a device to be charged,
the controller further configured to, in an event of a discrepancy, establish that a foreign body has been detected.

2. The apparatus as claimed in claim 1, wherein
the device to be charged is at least one of a mobile phone and a key for the motor vehicle.

3. The apparatus as claimed in claim 1, wherein
at least one of the gain control value and an automatic gain control value is an AGC value of a component and the AGC value is optionally used to diagnose at least one of an antenna and an antenna actuation.

4. The apparatus as claimed in claim 1, wherein
the controller is further configured to compare the gain control value of the component with the stored reference value at least one of without presence of the foreign body and during charging of the device to be charged in the charging apparatus.

5. The apparatus as claimed in claim 1, wherein
if a discrepancy between the gain control value of the component and the reference value stored in the apparatus for the device to be charged, is above a threshold value,
the controller establishes that a foreign body has been detected in an area of the apparatus.

6. The apparatus as claimed in claim 1, wherein
the controller is further configured to take the discrepancy between the gain control value of the component and the reference value stored in the apparatus for the device to be charged, as a basis for establishing a property of the detected foreign body.

7. The apparatus as claimed in claim 1, wherein
the controller is further configured to take the discrepancy between the gain control value of the component and the reference value stored in the apparatus for the device to be charged as a basis for deciding whether output of a warning is required.

8. The apparatus as claimed in claim 1, wherein
the controller is configured to at least one of detect and identify the device to be charged in an area of the apparatus.

9. The apparatus as claimed in claim 1, further comprising:
at least one of an antenna, a BUS connection, and an electronic controller for a motor vehicle.

10. The apparatus as claimed in claim 1, wherein
the controller is configured to control wireless charging of an energy store according to at least one standard for wirelessly charging an energy store in the device to be charged.

11. The apparatus as claimed in claim 1, wherein
the gain control value of the component is provided for matching at least one output driver of at least one of an antenna circuit of a communication module and a primary coil.

12. A method for detecting a foreign body using the apparatus as claimed in claim 1, comprising:
at the apparatus, detecting a foreign body in an area of the apparatus by comparing a present gain control value of a component with a reference value stored for the device to be charged.

13. The apparatus as claimed in claim 3 wherein the component is an NFC near field communication chip.

14. The apparatus as claimed in claim 3 wherein the component is an NFC3340 chip.

15. The apparatus as claimed in claim 6 wherein the property of the detected foreign body is at least one of a size or and a field influence of the detected foreign body.

16. The apparatus as claimed in claim 8 wherein the controller is configured to at least one of detect and identify the device to be charged in the area of the apparatus by at least one of near field communication, FOD detection, WLAN, mobile radio, and charging coils.

17. The apparatus as claimed in claim 10 wherein the at least one standard for wirelessly charging an energy store in the device to be charged is at least one of Qi standard and Powermat standard.
